(19) United States
(12) Patent Application Publication
(10) Pub. No.: US 2018/0202537 A1
(43) Pub. Date: Jul. 19, 2018

(54) FEED LIMIT VALVE INTEGRATED STOPSTART ACCUMULATOR

(71) Applicant: BorgWarner Inc., Auburn Hills, MI (US)

(72) Inventor: Mitsuru ISHIHARA, Novi, MI (US)

(21) Appl. No.: 15/744,105

(22) PCT Filed: Jul. 11, 2016
(86) PCT No.: PCT/US2016/041687

§ 371 Date: Jan. 12, 2018

Related U.S. Application Data
(60) Provisional application No. 62/192,285, filed on Jul. 14, 2015.

(51) Int. Cl. F16H 57/04; F16H 61/00; F16H 61/02

(52) U.S. Cl. CPC F16H 57/0435; F16H 61/0025; F16H 57/0446; F15B 1/04; F16H 2061/0037; F16H 2061/0034; F16H 2312/14; F16H 61/0276

(57) ABSTRACT

A pressurized oil supply system for a transmission of an automotive vehicle having an engine cut off system is provided that includes an accumulator, a supply line connected with the accumulator, a check valve fluidly connecting the accumulator with the supply line, a solenoid controlled valve fluidly connected with the accumulator, and a discharge line connected with the transmission. A feed line supplying transmission pump pressurized oil is provided. A metering valve connects the feed line with the supply line to regulate the oil pressure delivered to the supply line.

### FIELD OF THE INVENTION

The present invention relates to pressurized oil supply systems for automotive vehicles with engine cut off systems.

### BACKGROUND OF THE INVENTION

In the chronicles of automotive vehicle development, there's been a constant quest to increase vehicle fuel economy. One method to increase vehicle fuel economy is to shut the engine off when vehicle makes a stop. Vehicles with an engine cut off system need to provide a source of pressurize oil for the transmission when vehicle engine is restarted. One solution to the above noted need is to provide a transmission oil pump that is electrically driven. However, from a cost and vehicle operational efficiency standpoint electrically driven transmission oil pumps are not optimal.

It is desirable to provide a source pressurized oil for the transmission that is available for an engine driven transmission pump before the transmission pump has fully the pressurized the oil for the transmission. To meet the aforementioned challenge many automotive vehicle transmission pressured oil systems have an accumulator that stores a source of pressurized oil to make pressurized oil available to the transmission. A problem associated with such transmission pressurized oil systems is that the transmission pump operates over a relatively wide pressures range. The pressure delivered by engine powered transmission pump is often above that needed upon the restart of the vehicle transmission after a vehicle stop. Because of relatively large pressure values outputted by many engine driven transmission pumps the accumulator and its associated hardware including a solenoid valve must be specified to be of a sufficient strength and durability to handle relatively high transmission pump pressures. It is desirable provide a transmission pressurized oil supply system with an accumulator wherein less expensive and preferably lighter materials can be utilized such as polymeric materials and less expensive solenoid valves.

### SUMMARY OF THE INVENTION

To make manifest the above noted and other desires, a revelation of the present invention is brought forth. The present invention endows a freedom of a pressurized oil supply system for a transmission of an automotive vehicle having an engine cut off system that includes an accumulator, a supply line connected with the accumulator, a check valve fluidly connecting the accumulator with the supply line, a solenoid controlled valve fluidly connected with the accumulator and a discharge line connected with the transmission, a feed line supplying transmission pump pressurized oil, and a metering valve connecting with the feed line with the supply line while regulating the oil pressure delivered to the supply line.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of a preferred embodiment pressurized oil supply system for a transmission of an automotive vehicle having an engine cut off system according to the present invention; and

FIG. 2 is a schematic view of an alternate preferred embodiment pressurized oil supply system for a transmission of an automotive vehicle having an engine cut off system according to the present invention.

### DETAILED DESCRIPTION OF THE PREFERRED EMBODIMENTS

The following description of the preferred embodiment(s) is merely exemplary in nature and is in no way intended to limit the invention, its application, or uses.

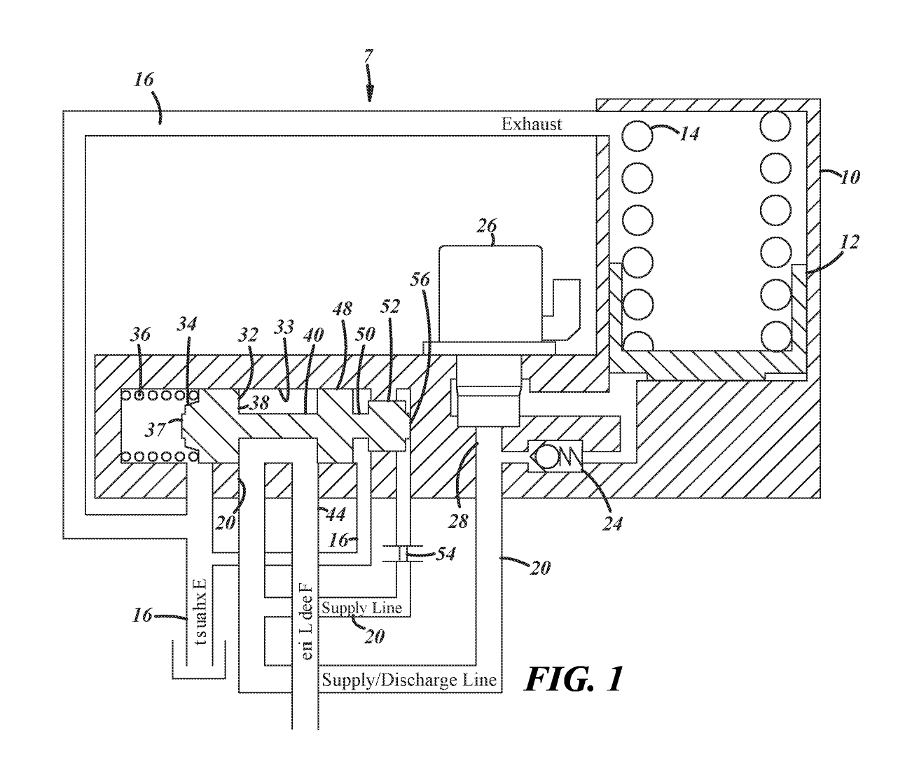

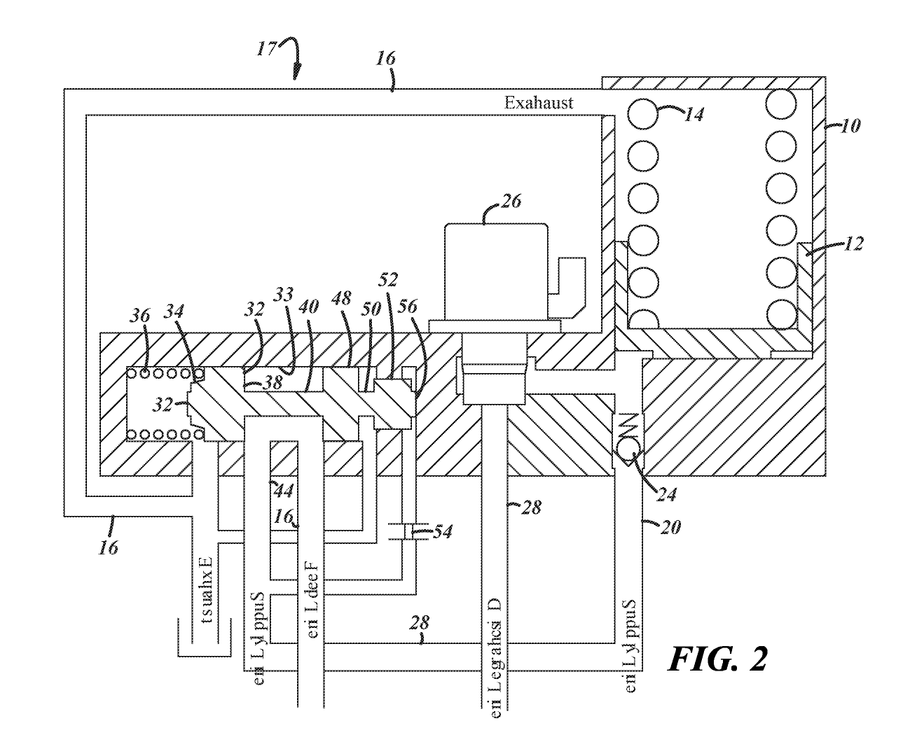

Referring to FIGS. 1 and 2, a pressurized oil supply system 7 for a transmission of an automotive vehicle having an engine shutoff system is provided. The system 7 has an accumulator 10. The accumulator 10 has a piston 12. Piston 12 is biased by a coil spring 14. The piston 12 and the accumulator 10 body may be fabricated from a metal such as steel or a suitable polymeric material such as plastic or a fiber reinforced material. The accumulator 10 is vented by a vent line 16 to allow for the removal of fluid which bypasses the piston 12 and to prevent the buildup of pressure behind the piston 12.

A supply line 20 is connected with the accumulator 10. A check valve 24 allows fluid to go from the supply line 20 into the accumulator 10 (when the pressure in the supply line 20 is greater than the pressure in the accumulator 10), but prevents fluid within the accumulator 10 from being discharged back into the supply line 20. The check valve 24 also prevents pressure loss from the accumulator 10 when the pressure in the supply line 20 is lower than the accumulator 10 pressure. A selectively opening and closing solenoid controlled valve 26 is fluidly connected with the accumulator 10 and a discharge line 28. The discharge line 28 is fluidly connected with the vehicle transmission (not shown). The discharge line 28 in the embodiment of the invention shown in FIG. 1 has much of its length in common with the supply line 20.

The pressurized oil supply system 7 also has a spool 32 metering valve. Spool 32 slides within a bore 33. Spool 32 has a first piston 34. One side of first piston 34 is engaged with a biasing spring 36. An opposite face 38 of the first piston 34 is connected with a first landing 40. The bore 33 intersects with a feed line 44 and the supply line 20 between the first piston 34 and a second piston 48. The first landing 40 is also connected with a second piston 48. The second piston on its face opposite the first landing 40 is exposed to the exhaust 16. The second piston 48 is connected with a second landing 50. The second landing 50 is connected with a third piston 52. A third piston 52 on its face opposite the landing is exposed to the supply line 20. A portion of the supply line 20 that is exposed to the third piston 52 has a restrictor 54. The third piston also has a reduced diameter face 56.

In operation, the supply system 7 receives pressurized oil from the transmission pump through the feed line 44. Feed line 44 shares landing 40 in common with the supply line 20. Pressurized oil travels through the supply line 20, then passes check valve 24 into accumulator 10 lifting up the piston 12 against its biasing spring 14. When it is desirable to release pressurized fluid back into an automotive transmission during periods of time after the engine has been shut off and transmission pump is no longer running, solenoid valve 26 is signaled from its closed position to open, thereby allowing fluid flow from the accumulator 10 back into the discharge line 28. Discharge line 28 is in common with the supply line 20. Discharged oil flows back spool valve to first landing 40 into the feed line 44 and from there goes to the vehicle transmission (not shown). The supply from the feed line 44 can often fluctuate in pressure. To limit the pressure of the pressurized oil delivered to the accumulator 10, excessive pressure will cause the spool 32 to be moved leftward due to the pressure in the supply line 20 acting upon the third piston 52. The leftward movement of the spool 32 causes the second piston 48 to meter of the flow coming from the feed line 44 to therefore reduce its pressure as it enters into the supply line 20. As the pressure in the supply line 20 is reduced the portion of the supply line 20 is exposed to the third piston 52 will lower its value therefore reducing its force acting upon the spool 32 in opposition to the spring 36. The spool's 32 movement is self-adjusting. A restrictor 54 within the supply line 20 which is exposed to third piston is added to reduce fluctuations in the pressure in the supply line 20 exposed to the third piston to. Fluid pressure buildup on the first piston 34 in the portion of the bore 33 wherein there is the biasing spring 36 is prevented by the exhaust 16 being exposed to the first piston's face 37. Pressurized oil supply system 7 allows for the use of an accumulator, check valve and solenoid in the 8 bar pressure range instead of a 20 bar system to match the possible transmission pump output. Lower pressures also facilitate housing the accumulator, solenoid valve mounting and spool valve in a common housing.

Referring to FIG. 2 alternate preferred embodiment pressurized oil supply system 17 according to the present invention is provided. Items forming like functions as those in FIG. 1 a given identical reference numbers. In the embodiment to, the discharge, line 28 is separate from the supply line. In most other aspects of the invention, pressurized fluid supply system 17 functions in a manner similar to or identical to the pressurized fluid supply system 7 shown in FIG. 1.

The description of the invention is merely exemplary in nature and, thus, variations that do not depart from the gist of the invention are intended to be within the scope of the invention. Such variations are not to be regarded as a departure from the spirit and scope of the invention.

1. A pressurized oil supply system for a transmission of an automotive vehicle having an engine cut off system comprising:
an accumulator;
a supply line connected with said accumulator;
a check valve fluidly connecting said accumulator with said supply line;
a solenoid controlled valve fluidly connected with said accumulator and a discharge line connected with the transmission;
a feed line supplying transmission pump pressurized oil; and
a metering valve connecting with said feed line with said supply line to regulate oil pressure delivered to said supply line.

2. The pressurized oil supply system of claim 1 wherein said supply line is separate from said discharge line.

3. The pressurized oil supply system of claim 1 wherein said supply line is in common with said discharge line.

4. The pressurized oil supply system of claim 1 wherein said accumulator has a spring biased piston.

5. The pressurized oil supply system of claim 1 wherein said metering valve includes a spool valve with said feed line and said supply line intersecting a bore of said spool valve between first and second pistons of said spool valve.

6. The pressurized oil supply system of claim 1 wherein said spool valve is spring biased by a spring engaging said first piston opposite said first landing.

7. The pressurized oil supply system of claim 1 wherein said supply line is exposed against a third piston of said spool valve.

8. The pressurized oil supply system of claim 7 wherein said third piston has a smaller diameter than said first and second pistons.

9. The pressurized oil supply system of claim 7 wherein there is a restriction in a portion of said supply line exposed to said third piston of said spool valve.

10. The pressurized oil supply system of claim 1 wherein said spool valve has 3 pistons, a first piston being exposed to an exhaust and said supply line, a second piston being exposed to said feed line and an exhaust, and a third piston expose to an exhaust and said supply line.

11. The pressurized oil supply system of claim 1 wherein said discharge line is not exposed to said check valve.

12. The pressurized oil supply system of claim 1 wherein said spool valve has a piston with one side exposed to said supply line and another side exposed to an exhaust.

13. The pressurized oil supply system of claim 10 wherein said third piston has a reduced diameter face.

14. A pressurized oil supply system for a transmission of an automotive vehicle having an engine cut off system comprising:
an accumulator;
a supply line connected with said accumulator;
a check valve fluidly connecting said accumulator with said supply line;
a solenoid controlled valve fluidly connected with said accumulator and a discharge line in common with said supply line connected with said transmission;
a feed line supplying transmission pump pressurized oil; and
a metering valve connecting with said feed line with said supply line to regulate oil pressure delivered to said supply line, said metering valve having a first spring biased piston, said first piston being exposed on side to an exhaust, said first piston being connected to a second piston by a first landing exposed to said supply line and said feed line, said second piston being exposed to said feed line on one side and said exhaust pressure on an opposite side, said second piston being connected by a second landing with a third piston being exposed to said supply line on a side of said third piston opposite said second piston.

15. A pressurized oil supply system for a transmission of an automotive vehicle having an engine cut off system comprising:
an accumulator;
a supply line connected with said accumulator;
a check valve fluidly connecting said accumulator with said supply line;
a solenoid controlled valve fluidly connected with said accumulator and a discharge line separate from said supply line and being connected with said transmission;
a feed line supplying transmission pump pressurized oil; and
a metering valve connecting with said feed line with said supply line to regulate oil pressure delivered to said supply line, said metering valve having a first spring biased piston, said first piston being exposed on side to an exhaust, said first piston being connected to a second piston by a first landing exposed to said supply line and said feed line, said second piston being exposed to said feed line on one side and said exhaust pressure on an opposite side, said second piston being connected by a second landing with a third piston being exposed to said supply line on a side of said third piston opposite said second piston.
